(19) United States
(12) Patent Application Publication
(10) Pub. No.: US 2010/0204891 A1
(43) Pub. Date: Aug. 12, 2010

(54) ACCELERATION CONTROL FOR VEHICLES HAVING A LOADER ARM

(75) Inventor: Joseph M. BIGGERSTAFF, Wichita, KS (US)

Correspondence Address: CNH AMERICA LLC;INTELLECTUAL PROPERTY LAW DEPARTMENT, P O BOX 1895, M.S. 641, NEW HOLLAND, PA, 17557, US

(73) Assignee: CNH AMERICA LLC, New Holland, PA (US)

(21) Appl. No.: 12/369,946

(22) Filed: Feb. 12, 2009

(51) Int. Cl. G06F 19/00

(52) U.S. Cl. 701/50; 701/70

(57) ABSTRACT

A control system for a vehicle having a loader arm, such as a skid steer loader, telescopic handler, wheel loader, backhoe loader or forklift, reads a load height sensor, a load weight sensor; dynamically calculates the static center of gravity of the combined vehicle and load; calculates the acceleration necessary to cause the dynamic center of gravity of the combined vehicle and load to extend exterior of the vehicle's stability polygon; and limits the acceleration of the vehicle to less than the acceleration necessary to cause the dynamic center of gravity of the combined vehicle and load to extend exterior of the vehicle's stability polygon.

### FIELD OF THE INVENTION

The present invention is directed to electronic control systems of work vehicles. More particularly, it relates to electronically controlled drive systems for work vehicles having a loader arm, such as skid steer loaders, telescopic handlers, wheel loaders, backhoe loaders or forklift skid steer loaders.

### BACKGROUND OF THE INVENTION

Vehicles having a loader arm, such as skid steer loaders, telescopic handlers, wheel loaders, backhoe loaders and forklifts, are a mainstay of construction work and industry. While the present invention will be described with regard to a skid steer loader, a forklift and a telescopic handler, it is applicable to any vehicle that has an implement to lift a load and is subject to tipping.

Skid steer loaders commonly have a loader or lift arm that is pivotally coupled to the chassis of the vehicle to raise and lower at the operator's command. This arm typically has a bucket, blade or other implement attached to the end of the arm that is lifted and lowered thereby. Perhaps most commonly, a bucket is attached, and the skid steer vehicle is used to carry supplies or particulate matter such as gravel, sand, or dirt around the worksite.

One of the disadvantages of traditional skid steer vehicles is their potential lack of stability when a loaded implement is raised, particularly when the load is extremely heavy. Such a condition leads to instability and potential tipping of the vehicle off its wheels. This is particularly true when the vehicle is accelerated, i.e., the rate of speed of the vehicle is increased, the rate of speed of the vehicle is decreased, the direction of travel is changed, or any combination. The instability problem is exacerbated when the vehicle travels up or down an incline, or over irregular terrain.

Skid steer loaders have a relatively compact wheelbase. They are loaded by filling a bucket and raising the bucket in the air above the operator's head. The loaded bucket is not disposed at the center of the vehicle with its weight evenly distributed overall four wheels, but is typically cantilevered outward away from the vehicle at the front wheels. In addition, a sprung skid steer loader can roll and pitch to a much greater degree than an unsprung skid steer. All of these factors combined could make a skid steer loader unstable and subject to tipping.

### SUMMARY OF THE INVENTION

Other features and advantages of the present invention will be apparent from the following more detailed description of the preferred embodiment, taken in conjunction with the accompanying drawings which illustrate, by way of example, the principles of the invention.

In accordance with a first embodiment of the present invention, a vehicle having a loader arm capable of carrying a load and having a stability polygon also has (a) a device for sensing the weight of the load and generating a signal indicative thereof, (b) a device for sensing the height of the load and generating a signal indicative thereof, and (c) an electronic controller. The electronic controller is coupled to the device for sensing weight and the device for sensing height, and is programmed (i) to dynamically calculate the static center of gravity of the combined vehicle and load based upon the signals received from the device for sensing weight and the device for sensing height, (ii) to calculate the acceleration necessary to cause the dynamic center of gravity of the combined vehicle and load to extend exterior of the stability polygon for the vehicle, and (iii) to generate a signal to limit the acceleration of the vehicle to less than the dynamically calculated acceleration necessary to cause the dynamic center of gravity of the combined vehicle and load to extend exterior of the stability polygon for the vehicle.

A second embodiment of the present invention is a method of controlling a vehicle having a loader arm capable of carrying a load and having a stability polygon. The method includes (a) receiving a signal representative of the weight of the load, (b) receiving a signal representative of the height of the load, (c) combining the signals representative of the weight and height of the load to dynamically calculate the static center of gravity of the combined vehicle and load, (d) dynamically calculating the acceleration necessary to cause the dynamic center of gravity of the combined vehicle and load to extend exterior of the stability polygon for the vehicle; and (e) generating a signal to limit the acceleration of the vehicle to less than the dynamically calculated acceleration necessary to cause the dynamic center of gravity of the combined vehicle and load to extend exterior of the stability polygon for the vehicle.

Another embodiment of the present invention is a drive control system for a vehicle having a loader arm capable of carrying a load and having a stability polygon. The drive control system includes (a) a device for sensing the weight of the load and generating a signal indicative thereof, (b) a device for sensing the height of the load and generating a signal indicative thereof, and (c) an electronic controller for receiving the signals generated by the device for sensing the weight and height of the load. The electronic controller is programmed (i) to dynamically calculate the static center of gravity of the combined vehicle and load based upon the signals received from the device for sensing the weight and height of the load, (ii) to calculate the acceleration necessary to cause the dynamic center of gravity of the combined vehicle and load to extend exterior of the stability polygon for the vehicle, and (iii) to generate a signal to limit the acceleration of the vehicle to less than the dynamically calculated acceleration necessary to cause the dynamic center of gravity of the combined vehicle and load to extend exterior of the stability polygon for the vehicle.

### BRIEF DESCRIPTION OF THE DRAWINGS

FIG. 1 is a side view of a skid steer loader in accordance with the present invention.

FIG. 2 is a schematic illustration of a stability region, quadrangle or polygon of the skid steer loader of FIG. 1.

FIG. 3 is a side view of a forklift in accordance with the present invention.

FIG. 4 is a schematic illustration of a stability region, triangle or polygon of the forklift of FIG. 3.

FIGS. 5A and 5B are schematic illustrations showing relationships between a stability polygon of a telescopic handler and increasing boom height.

FIG. 6 is a schematic diagram of an electronic control system corresponding to a stability polygon for a vehicle.

FIG. 7 is a flow chart corresponding to a stability polygon of a vehicle.

### DETAILED DESCRIPTION OF THE INVENTION

While the invention has been described with reference to a number of embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

The first embodiment described below is a skid steer loader having a differential drive system in which the wheels on each side of the vehicle can be driven independently of each other. The loader may include an electronic control system capable of electronically monitoring the skid steer loader's load, the height of that load, and of responsively derating or reducing the drive system's response to operator commands. The electronic control system combines these sensor signals and, based on dynamically, i.e., continuously, calculating whether to and how much to derate the drive system.

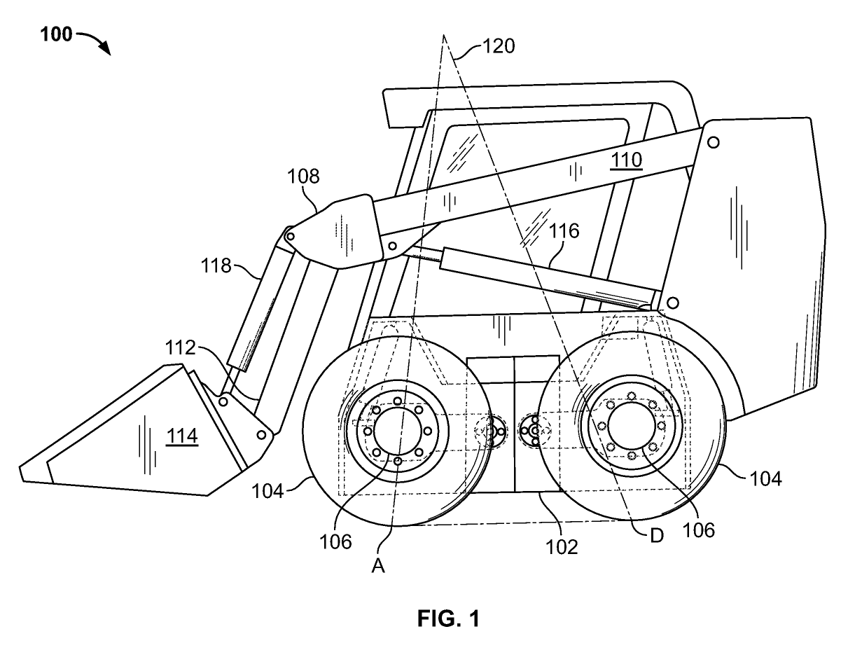

Referring to FIG. 1, a skid steer loader 100 is illustrated having a chassis 102 to which four wheels 104 are coupled in fore-and-aft relation, two wheels on each side of the vehicle, each wheel being coupled to and driven by a corresponding hydraulic drive motor 106. A mechanical linkage in the form of two loader arms or lift arms 108 are pivotally coupled to the chassis 102 of the loader 100 at one end 110 of the arms. The other end 112 of the arms is pivotally connected to an implement (herein shown as a bucket 114) that performs useful work. In the side view of FIG. 1, only one arm 108 can be seen. The other arm 108 is mounted on the other side of the vehicle in the same position as the arm shown in FIG. 1.

Two actuators, here exemplified as hydraulic lift cylinders 116 are coupled to and between the arms 108 and the chassis 102 of the vehicle to lift the arms 108 with respect to the chassis 102. Two additional actuators, here shown as a pair of hydraulic bucket cylinders 118 are similarly coupled to and between the bucket 114 and the loader arms 108 to pivot the bucket with respect to the loader arms.

While the actuators shown here are hydraulic cylinders, they may be electric, hydraulic or pneumatic actuators. The mechanical linkage, shown here as a pair of loader arms, may be one or more loader arms in any combination of bars or mechanical links that is configured to lift or lower the implement. The implement, shown here as bucket 114, need not be a bucket, but may be any implement coupled to the end of the mechanical linkage to perform work.

In FIG. 1 the vehicle is supported on four wheels, each of which is driven by a corresponding individual hydraulic motor. While this arrangement is preferred, other arrangements are also considered satisfactory, such as two motors, one for each side of the vehicle that are coupled to one or more wheels on each side of the vehicle. There may be six or eight wheels. The wheels may be pneumatic or solid. The wheels may be metal, rubber or plastic. Some or all may be driven. A track may extend around the wheels to form a tracked drive.

In one embodiment, the illustrated motors are hydraulic. In the alternative, they may be electrical or pneumatic. The motors may be directly coupled to the wheels they drive. They may also be indirectly coupled through shaft, gear, belt, chain and gearbox arrangements that extend between the motor and the wheel or wheels to which the motor is coupled.

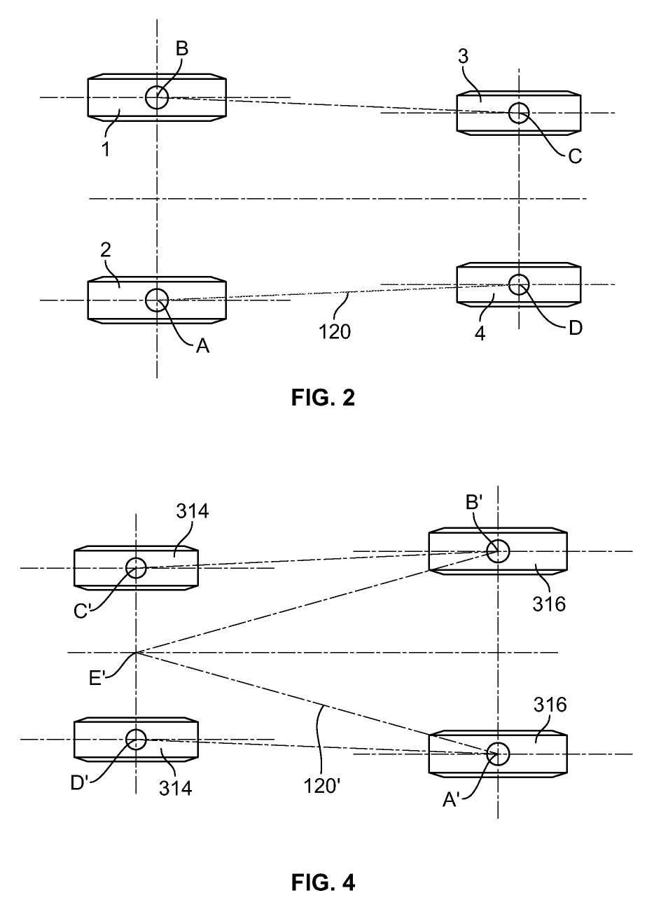

The concept of a vehicle's “stability pyramid”, which is a key to keeping the vehicle upright and operating safely is now disclosed. As long as the center of gravity of the combined vehicle and load is kept inside its imaginary stability pyramid, there is reduced risk of the vehicle tipping over. As shown in FIG. 2, the stability pyramid 120 for loader 100 may be determined by drawing an imaginary line between the support points A, B, C and D, i.e., where the supporting wheels 1, 2, 3 and 4 contact the ground. In the case of a vehicle with four independently hung wheels, the resulting quadrangle is the base of the machine's stability pyramid.

In one embodiment, the top point, or peak, of the stability pyramid 120 for loader 100 is located somewhere just above the operator's head. The peak of the stability pyramid 120 is positioned along a vertical line drawn through the static center of gravity of the combined vehicle and load. The height of the stability pyramid 120 depends on the height of the load, and fore and aft location of the stability pyramid 120 is determined by the position of the bucket 114.

The stability pyramid 120 grows taller or shrinks, skews or becomes more vertical as the operator raises and lowers the bucket 114. When the bucket 114 is maintained in a position near the wheel operating surface, the stability pyramid 120 is short and broad, making it relatively stable. Raising the bucket 114 elongates the stability pyramid 120, making it tall and narrow, and the loader 100 much more susceptible to tipping.

The center of gravity rises as the load rises, and needs only to shift a short distance to get outside the narrow top of the imaginary stability pyramid 120 and cause the loader 100 to be much more susceptible to tipping, especially if the loader 100 is moving. Momentum multiplies the torque caused by turning or operating on sloping or rough surfaces, dramatically increasing the potential for tipping.

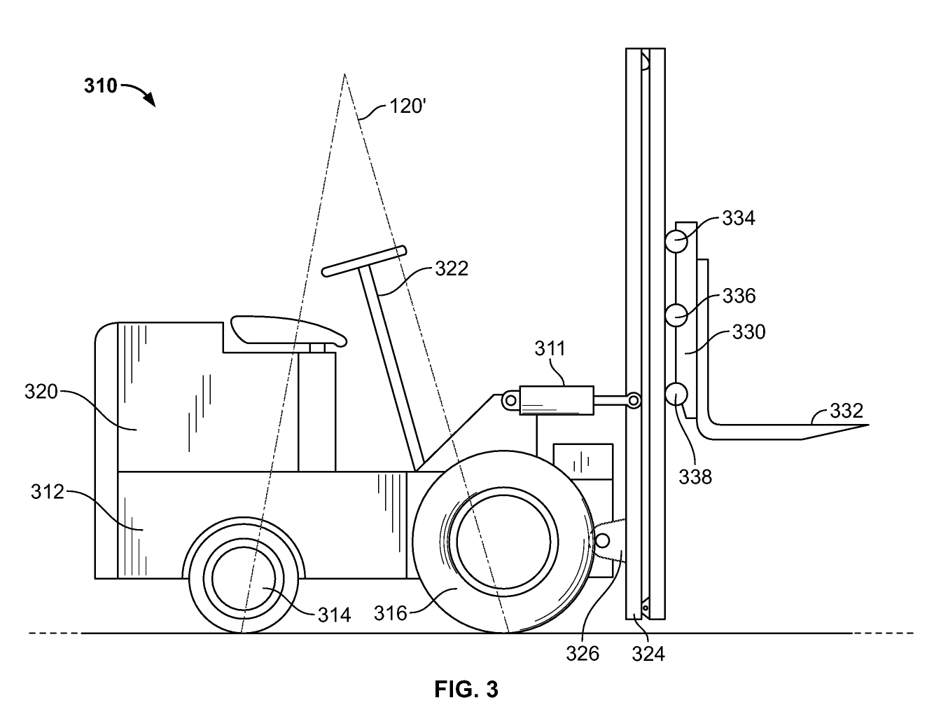

Referring to FIG. 3, forklift 310 comprises a main frame 312 supported at its rear end by a pair of wheels 314 and at its forward end by a pair of driving wheels 316. The forklift 310 is further provided with an internal combustion engine or battery-powered engine 320, connected through a suitable clutch and power transmission mechanism to the driving wheels 316 and with a steering wheel 322 and a suitable mechanism (not shown) joined to the rear wheels 314 to steer the forklift 310.

Mast 324 is pivotally connected to the main frame 312 of the forklift 310 by a set of ears 326 and a pivot pin. The mast 324 may be mounted in a fixed upright position by a suitable bracing structure connected to the forward end of the forklift 310 or may be pivotally mounted on the forklift and connected by a pair of tilting rams 311 between the frame 312 and the mast 324. This pivoting action of the mast 324 assists in controlling the center of gravity of the forklift 310 as the load is lifted.

A load-lifting carriage 330 is joined to the mast 324. The carriage supports a pair of forks 332 (only one being shown). The carriage 330 is guided in movement along the mast 324 by a set of rollers 334, 336, 338. The principles of the invention may be applied to any forklift truck body or frame.

FIG. 4 shows a plan view of the stability pyramid 120′ for the forklift 310 of FIG. 3. The stability pyramid 120′ on a counterbalanced forklift is independent of whether the vehicle has three wheels or four wheels. At first glance it would seem that the stability pyramid of a four-wheeled lift truck would have a rectangular or quadrangle base instead of a triangle, but that is not the case. The steering axle pivots on its center pin, and that pivot pin becomes the third point forming the triangular base of the stability pyramid. Therefore, the base of the stability pyramid 120′ is formed by the front support points A′ and B′ on the driving wheels 316 and the rear axle suspension point E′ of the floating or swing axle.

In the transverse direction, the forklift 310 will initially tip along the line B′-E′ or A′-E′. If the floating axle comes into contact on one side against a stop or if its floating or swing movement is blocked, the tip E′ of the stability triangle A′-B′-E′ shifts to the support points C′ and D′ on the rear wheels 314. The tipping of the forklift in the transverse direction is then determined by the line B′-C′ or A′-D′.

In the longitudinal direction, the forklift 310 can tip forward about the axis A′-B′, for example, if the load is sufficiently heavy and the forklift 310 is braked suddenly. If the forklift 310 is accelerated, dynamic center of gravity shifts to the rear and the forklift 310 tends to tip about axis C′-D′.

As shown in FIG. 3, the top point, or peak, of the stability pyramid 120′ for forklift 310 is located somewhere just above the operator's head. The peak of the stability pyramid 120′ is along a vertical line drawn through the static center of gravity of the combined vehicle and load. The height of the stability pyramid 120′ depends on the height of the load, and fore and aft location of the stability pyramid 120′ is determined by the position of the forks 332.

The stability pyramid 120′ elongates or contracts, skews or becomes more vertical as the operator manipulates the forks 332. When the forks 332 are maintained in a position near the wheel operation surface, the stability pyramid 120′ is short and broad, making it relatively stable. Raising the forks 332 elongates the stability pyramid 120′, making it tall and narrow, and the forklift 310 much more susceptible to tipping.

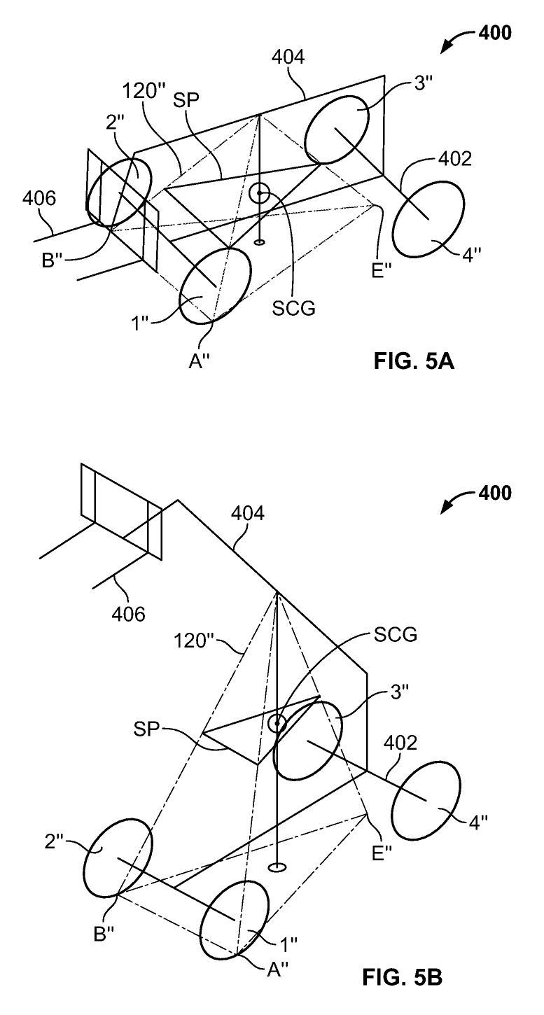

The center of gravity rises as the load rises, and needs only to shift a short distance to get outside the narrow top of the imaginary stability pyramid 120, 120′ and cause the loader 100 or forklift 310 to be much more susceptible to tipping, especially if the loader 100 or forklift 310 is moving. Shrinking of the stability polygon is more clearly shown in FIGS. 5A and 5B, which schematically illustrates a telescopic handler 400.

The telescopic handler 400 includes two drive wheels 1″ and 2″ and two steering wheels 3″ and 4″ mounted on a single pivot rear axle 402. Therefore, the base of the stability pyramid 120″ is a triangle A″-B″-E″. A boom 404 is mounted on the frame of the telescopic handler 400 and supports a pair of pallet forks 406.

As with the previous vehicles, the top point, or peak, of the stability pyramid 120″ for telescopic handler 400 is located somewhere just above the operator's head. As shown in FIGS. 5A and 5B, the peak of the stability pyramid 120″ is along a vertical line drawn through the static center of gravity SCG of the combined vehicle and load. The height of the stability pyramid 120″ depends on the height of the load carried on the pallet forks 406, and fore and aft location of the stability pyramid 120″ is determined by the position of the pallet forks 406.

Comparing FIGS. 5A and 5B, the stability pyramid 120″ elongates or contracts as the operator manipulates the pallet forks 406. When the pallet forks 406 are maintained in a position near the wheel operating surface, the stability pyramid 120″ is short and broad, as shown in FIG. 5A, making it relatively stable. Raising the pallet forks 406 elongates the stability pyramid 120″, making it tall and narrow, as shown in FIG. 5B, and the telescopic handler 400 much more susceptible to tipping.

The static center of gravity SCG rises as the load rises. When the center of gravity falls outside the stability polygon SP defined by the horizontal cross-section of the stability pyramid 120″ containing the static center of gravity SCG, the vehicle will tip. As the static center of gravity SCG is moved upwardly, the stability polygon is reduced and only a small shift in the center of gravity will cause the center of gravity to fall outside the stability polygon SP. Therefore, when the static center of gravity SCG is moved upwardly, the vehicle is becomes less unstable.

The critical center of gravity that must stay within the stability polygon SP to prevent the vehicle from tipping over is the dynamic center of gravity DCG, which is calculated by adding the static center of gravity SCG and acceleration of the vehicle. Acceleration is caused by increasing the speed of the vehicle, decreasing the speed of the vehicle, or changing the direction of the travel of the vehicle.

To deter the vehicle from tipping, the acceleration of the vehicle is limited to less than the acceleration necessary to cause the dynamic center of gravity DCG of the combined vehicle and load to extend exterior of the stability polygon SP. The acceleration is limited by dynamically calculating the static center of gravity SCG based on the weight of the load carried by the vehicle implement and the height of the load, and dynamically calculating the acceleration necessary to cause the dynamic center of gravity DCG to extend exterior of the stability polygon SP. The rate of increase in the speed of the vehicle, the rate of decrease in the speed of the vehicle and the rate of change in the direction of the vehicle is limited to less than the dynamically calculated acceleration necessary to cause the dynamic center of gravity DCG to extend exterior of the stability polygon SP.

A predetermined tolerance or buffer between an acceptable reading and the actual stability polygon may be incorporated into the calculation. Therefore, the phrase “extend exterior of the stability polygon for the vehicle” is intended to mean “extend into the buffer or tolerance of the calculated stability polygon”.

As a further precaution, an alarm may be mounted on the vehicle and be activated when the dynamic center of gravity DCG to approaches the edge of the stability polygon SP. The alarm may be either visual, such as a warning light, or audible, or a combination.

The relative position of the vehicle with respect to horizontal affects both the size and shape of the base of the stability pyramid and the combined center of gravity of the vehicle and load. Therefore, the relative position of the vehicle with respect to horizontal may also be used in the calculation of the static center of gravity SCG and the acceleration necessary to cause the dynamic center of gravity DCG to extend exterior of the stability polygon SP. The relative position can be determined by an incline meter, a gyroscope or other means.

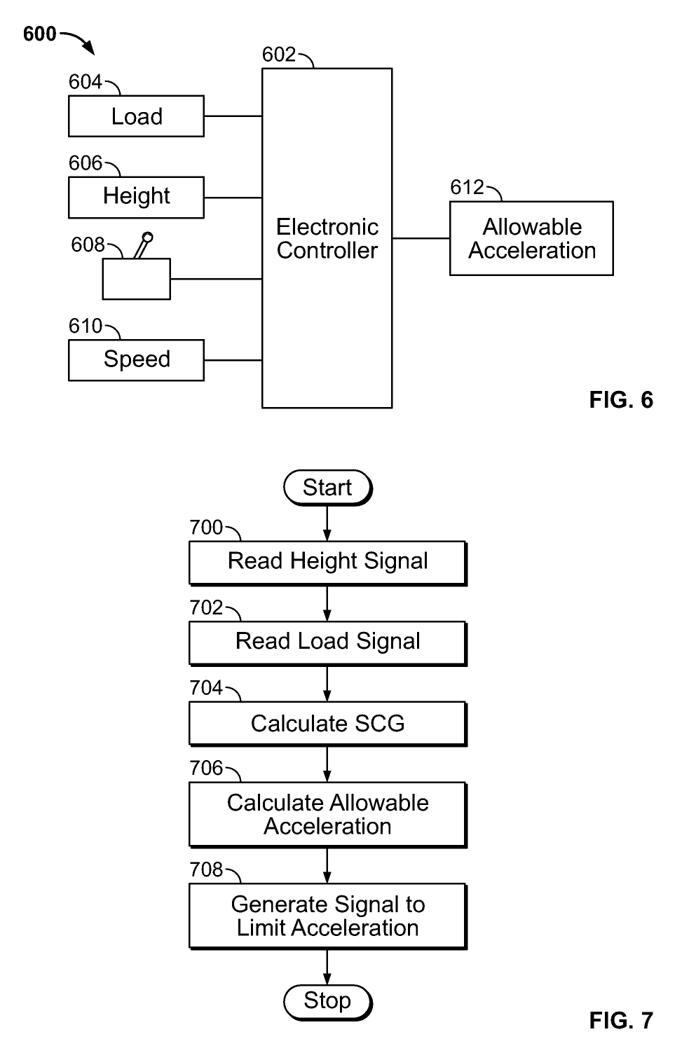

The vehicle's electronic control system provides the ability to dynamically calculate the static center of gravity SCG and the acceleration necessary to cause the dynamic center of gravity DCG of the combined vehicle and load to extend exterior of the stability polygon SP for the vehicle. FIG. 6 illustrates the electronic control system in more detail.

The electronic control system 600 may include an electronic controller 602 which includes one or more individual microcontrollers or microprocessors that may be networked over a serial communication bus such as a CAN bus (not shown). Other arrangements of microcontrollers and microprocessors may be used. There may be several sensors connected to the electronic controller 602 that provide the electronic controller with data indicating both vehicle load and the relative height of the load with respect to the base of the stability pyramid 120,120′, 120″.

A first of these sensors is load sensor 604. In one embodiment, this sensor is a pressure sensor in fluid communication with the implement lift cylinder to generate a signal indicative of fluid pressure in the cylinder. As the load increases in the implement, the hydraulic fluid pressure required to lift the implement increases. The pressure in the hydraulic lift cylinders therefore indicates at least in part the load placed in the implement. The particular relationship of pressure to implement load depends, of course, upon the particular configuration and arrangement of the implement loader arms supporting the implement. In an alternative embodiment, the load sensor can be a pressure sensor coupled to a suspension cylinder. The load sensor can alternatively be a pressure sensor coupled to a pneumatic tire of the vehicle to sense tire pressure.

A second of these sensors is a position or height sensor 606. In one embodiment, height sensor 606 may be coupled to one of the lift cylinders to generate a signal indicative of lift cylinder extension. The sensor may be a rotary position sensor or a linear position sensor coupled to the moveable structure of the loader arms or any other portion of the linkage. The sensor may be a non-contact sensor such as a proximity sensor that generates a relative position signal that is based on capacitance or inductance. The sensor may be a radiation sensor such as an ultrasonic, radar, or laser sensor that measures distance. The sensor may be a flow sensor indicating fluid flow into or out of a hydraulic cylinder or other actuator that is related to the actuator position, such as a flow sensor coupled to the lift cylinder. Alternately, the sensor may be a sensor responsive to remote signals correlated to height, such as such as a GPS or barometric pressure sensor.

The electronic controller 602 may also be coupled to an operator input device 608 that is manipulable by the operator to signal a desired direction and speed of travel. Device 608 may be a joystick or a steering wheel and throttle arrangement or other arrangement. The joystick may generate two signals, a first signal indicating the deflection of the joystick along a fore-and-aft axis parallel to the fore-and-aft axis of the skid steer vehicle, and a second signal indicating the deflection along an orthogonal side-to-side axis parallel to the side-to-side axis of the skid steer vehicle.

Generally speaking, the operator indicates his desire to go straight forward or straight backward by moving the joystick straight forward or straight backward, respectively, with no deflection of the lever in a side-to-side direction. The operator indicates his desire to turn to the left or the right by moving the joystick side-to-side along the lateral axis of the joystick (i.e., to the right or to the left).

The electronic controller 602 may also be coupled to a speed sensor 610 that generates a signal indicating the fore-and-aft velocity of the skid steer loader. Speed sensors may be wheel speed sensors disposed to sense the speed of wheels 1, 2, 3, 4, or hydrostatic motor speed sensors disposed to sense the speed of the wheel drive motors, or GPS receivers, lasers, or ground-sensing radars on the vehicle and disposed to sense the speed of the ground with respect to vehicle.

The electronic control system 600 is configured to receive signals indicating the height of the load above the vehicle and the amount of load on the vehicle, and optionally, the speed of the vehicle, the direction and speed of travel desired by the operator. Electronic controller 602 combines the load and load height signals to dynamically calculate the static center of gravity SCG and dynamically calculate the acceleration necessary to cause the dynamic center of gravity of the combined vehicle and load to extend exterior of an edge of the stability polygon SP for the vehicle, and generates an allowable acceleration signal 612. If the commanded change in speed or direction of travel would cause the actual acceleration to exceed the acceleration necessary to cause the dynamic center of gravity of the combined vehicle and load to extend exterior of an edge of the stability polygon SP for the vehicle, the rate of change in speed or direction of travel will be reduced or limited.

In another embodiment, the static center of gravity SCG may be determined by measuring the weight on each tire or the weight on the front axle and the rear axle in combination with the incline or relative position of the vehicle, the loader arm position, the weight of the vehicle and the weight of the load. The static center of gravity SCG may then be calculated as known in the art.

FIG. 7 illustrates the process performed by electronic controller 602 when it responds to operator manipulation of the operator input device 608. In block 700, controller 602 reads the height signal generated by height sensor 606 that indicates the height of the vehicle load. Controller 602 saves the height signal for use in later computations.

In block 702, controller 602 reads the load signal generated by load sensor 604 that varies with the load applied by the implement coupled to the loader arms. Controller 602 saves this signal for use in further computations.

In block 704, controller 602 dynamically calculates the static center of gravity SCG. In block 706, controller 602 dynamically calculates the acceleration necessary to cause the dynamic center of gravity DCG of the combined vehicle and load to extend exterior of the stability polygon SP for the vehicle.

In block 708, controller 602 generates a signal to limit the acceleration of the vehicle to less than the dynamically calculated acceleration necessary to cause the dynamic center of gravity of the combined vehicle and load to extend exterior of an edge of the stability polygon for the vehicle. If the particular vehicle operating conditions cause the dynamic center of gravity of the combined vehicle and load to extend exterior of the stability polygon for the vehicle, the acceleration is limited by controller 602.

Limiting the acceleration of the vehicle may include controller 602 reading the position signal generated by operator input device 608 that indicates the position of the operator input device 608. Whether input device 608 is a joystick, multiple levers or some similar device, the input device generates a signal defining a commanded speed and direction and degree of turning of the vehicle. Controller 602 may also read the speed sensor signal 610 that is indicative of the speed of the vehicle to determine the acceleration that would occur in response to a commanded change in direction of travel of the vehicle.

1. A vehicle having a loader arm capable of carrying a load and having a stability polygon comprising:
a device for sensing the weight of the load and generating a signal indicative thereof;
a device for sensing the height of the load and generating a signal indicative thereof;
an electronic controller coupled to the device for sensing the weight and height of the load, and programmed to dynamically calculate the static center of gravity of the combined vehicle and load based upon the signals received from the device for sensing the weight and height of the load, to calculate the acceleration necessary to cause the dynamic center of gravity of the combined vehicle and load to extend exterior of the stability polygon for the vehicle, and to generate a signal to limit the acceleration of the vehicle to less than the dynamically calculated acceleration necessary to cause the dynamic center of gravity of the combined vehicle and load to extend exterior of the stability polygon for the vehicle.

2. The vehicle of claim 1, wherein the signal generated by the electronic controller limits the rate of increase in the speed of the vehicle, limits the rate of decrease in the speed of the vehicle, or limits both the rate of increase and the rate of decrease in the speed of the vehicle.

3. The vehicle of claim 1, wherein the signal generated by the electronic controller limits the rate of change in direction of travel of the vehicle.

4. The vehicle of claim 1, wherein the vehicle includes an alarm and wherein the signal generated by the electronic controller activates the alarm.

5. The vehicle of claim 1, wherein the stability polygon is calculated by the electronic controller based upon the height of the center of gravity of the combined vehicle and load.

6. The vehicle of claim 1, wherein the stability polygon is a stability triangle or a stability quadrangle.

7. The vehicle of claim 1, further comprising a device for sensing the position of the vehicle with respect to horizontal and generating a signal indicative thereof, and wherein the electronic controller is programmed to dynamically calculate the static center of gravity of the combined vehicle and load also based upon the signal received from the device for sensing the position of the vehicle with respect to horizontal.

8. The vehicle of claim 1, wherein the vehicle is selected from the group consisting of a skid steer loader, a telescopic handler, a wheel end loader and a forklift.

9. A method of controlling a vehicle having a loader arm capable of carrying a load and having a stability polygon comprising:
receiving a signal representative of the weight of the load;
receiving a signal representative of the height of the load;
combining the signals representative of weight and height of the load to dynamically calculate the static center of gravity of the combined vehicle and load;
dynamically calculating the acceleration necessary to cause the dynamic center of gravity of the combined vehicle and load to extend exterior of the stability polygon for the vehicle; and
generating a signal to limit the acceleration of the vehicle to less than the dynamically calculated acceleration necessary to cause the dynamic center of gravity of the combined vehicle and load to extend exterior of the stability polygon for the vehicle.

10. The method of control system of claim 9, wherein the rate of increase in the speed of the vehicle is limited, the rate of decrease in the speed of the vehicle is limited, or both the rate of increase and the rate of decrease in the speed of the vehicle is limited.

11. The method of control system of claim 9, wherein the rate of change in direction of travel of the vehicle is limited.

12. The method of control system of claim 9, wherein the vehicle includes an alarm and wherein the alarm activates when the acceleration of the vehicle approaches the dynamically calculated acceleration necessary to cause the dynamic center of gravity of the combined vehicle and load to extend exterior of the stability polygon for the vehicle.

13. The method of control system of claim 9, wherein the stability polygon is based upon the height of the center of gravity of the combined vehicle and load.

14. The method of control system of claim 9, wherein the stability polygon is a stability triangle or a stability quadrangle.

15. The method of control system of claim 9, wherein the static center of gravity of the combined vehicle is calculated also based upon the position of the vehicle with respect to horizontal.

16. The method of control system of claim 9, wherein the vehicle is selected from the group consisting of a skid steer loader, a telescopic handler, a wheel loader, a backhoe loader and a forklift.

17. A drive control system for a vehicle having a loader arm capable of carrying a load and having a stability polygon, the drive control system comprising:
a device for sensing the weight of the load and generating a signal indicative thereof;
a device for sensing the height of the load and generating a signal indicative thereof;
an electronic controller for receiving the signals generated by the device for sensing the weight and height of the load, and programmed to dynamically calculate the static center of gravity of the combined vehicle and load based upon the signals received from the device for sensing the weight and height of the load, to calculate the acceleration necessary to cause the dynamic center of gravity of the combined vehicle and load to extend exterior of the stability polygon for the vehicle, and to generate a signal to limit the acceleration of the vehicle to less than the dynamically calculated acceleration necessary to cause the dynamic center of gravity of the combined vehicle and load to extend exterior of the stability polygon for the vehicle.

18. The drive control system of claim 17, further comprising device to limit the rate of increase in the speed of the vehicle, to limit the rate of decrease in the speed of the vehicle, or limit both the rate of increase and decrease in the speed of the vehicle, in response to the signal generated by the electronic controller.

19. The drive control system of claim 17, further comprising device to limit the rate of change in direction of travel of the vehicle, in response to the signal generated by the electronic controller.

20. The drive control system of claim 17, further comprising an alarm and device to activate the alarm, in response to the signal generated by the electronic controller.
